(19) United States
(12) Patent Application Publication
(10) Pub. No.: US 2015/0028520 A1
(43) Pub. Date: Jan. 29, 2015

(54) METHOD FOR MAKING A FEMALE MEMBER OF A HOOK-AND-LOOP FASTENER

(71) Applicant: KANG NA HSIUNG ENTERPRISE CO., LTD., Tainan City (TW)

(72) Inventors: Jung-Chi Tai, Tainan City (TW); Ho-Hsi Yang, Tainan City (TW); Chien-Chung Su, Tainan City (TW)

(73) Assignee: KANG NA HSIUNG ENTERPRISE CO., LTD., Tainan City (TW)

(21) Appl. No.: 14/221,562

(22) Filed: Mar. 21, 2014

(30) Foreign Application Priority Data
Jul. 29, 2013 (TW) 102127107

(51) Int. Cl. B29C 65/18

(52) U.S. Cl. CPC B29C 65/18
USPC 264/258

(57) ABSTRACT

A method for making a female member of a hook-and-loop fastener includes the steps of: (a) bonding together a base layer and a surface layer, that is formed from a fiber material and that is superimposed on the base layer, by applying heat to the surface layer so that fibers of the surface layer are curled; and (b) immediately after step (a), subjecting the surface layer to a rapid cooling treatment so as to set the curled fibers of the surface layer.

### CROSS-REFERENCE TO RELATED APPLICATION

This application claims priority of Taiwanese Application No. 102127107, filed on Jul. 29, 2013.

### BACKGROUND OF THE INVENTION

1. Field of the Invention

The invention relates to a method for making a female member of a hook-and-loop fastener.

2. Description of the Related Art

Referring to FIG. 1, a conventional hook-and-loop fastener includes a male member 11 and a female member 12. The male member 11 includes a plurality of hooks 111 formed on a surface thereof. The female member 12 includes a plurality of loops 121 formed on a surface thereof. When the male member 11 and the female member 12 are brought face-to-face and are pressed toward each other, the hooks 111 and the loops 121 will become tangled to create a plurality of mechanical connections. When a sufficient pulling force is subsequently applied to separate the male and female members 11, 12, the hooks 111 could be torn away from the loops 121. Therefore, the male member 11 can be separated from the female member 12 at this time

However, if the mechanical strength of the loops 121 of the female member 12 is not sufficient to strongly hold the hooks 111 of the male member 11, the male member 11 and the female member 12 are easily separated from each other under an unexpected situation as a result of local deformation or abrupt strain of the fastener.

U.S. 2011/0118692 A1 discloses a female member for a hook-and-loop fastener, in which a plurality of lines of dense fiber portions and a plurality of lines of sparse fiber portions are arranged alternatingly in a specific orientation so as to enhance an interlocking strength between the female member and a male member. The dense fiber portions are formed by piling a fibrous material using a hot blast, and the sparse fiber portions are formed by removing the fibrous material using the hot blast.

### SUMMARY OF THE INVENTION

The object of the present invention is to provide a method for making a female member of a hook-and-loop fastener that may enhance interlocking strength of the female member with a male member of the hook-and-loop fastener.

According to this invention, there is provided a method for making a female member of a hook-and-loop fastener. The method includes the steps of:
(a) bonding together a base layer and a surface layer, that is formed from a fiber material and that is superimposed on the base layer, by applying heat to the surface layer so that fibers of the surface layer are curled; and
(b) immediately after step (a), subjecting the surface layer to a rapid cooling treatment so as to set the curled fibers of the surface layer.

An advantage of the present invention is that the curled fibers of the surface layer from step (a) are set by the rapid cooling treatment immediately after step (a). Therefore, when the female and male members of the hook-and-loop fasteners are pressed toward each other, the hooks of the male member easily clasp the loops of the female member so as to generate an excellent binding force.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic perspective view of a conventional hook-and-loop fastener;

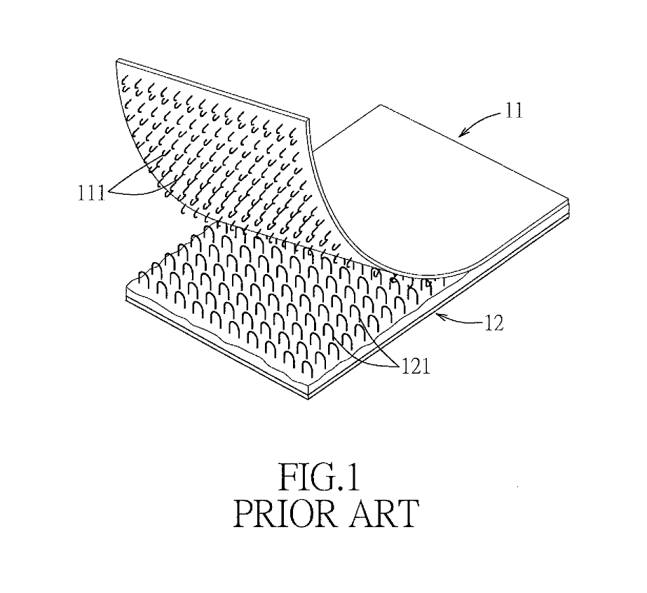

FIG. 2 is a schematic perspective diagram illustrating a first preferred embodiment of a method for making a female member of a hook-and-loop fastener according to this invention;

FIG. 3 is a fragmentary schematic view showing the female member of the hook-and-loop fastener made according to the first preferred embodiment;

FIG. 4 is a schematic perspective diagram illustrating a second preferred embodiment of a method for making a female member of a hook-and-loop fastener according to this invention;

FIG. 5 is a schematic perspective diagram illustrating a third preferred embodiment of a method for making a female member of a hook-and-loop fastener according to this invention;

FIG. 6 is a schematic perspective diagram illustrating a fourth preferred embodiment of a method for making a female member of a hook-and-loop fastener according to this invention;

FIG. 7 is a schematic perspective diagram illustrating a fifth preferred embodiment of a method for making a female member of a hook-and-loop fastener according to this invention;

FIG. 8 is a schematic perspective diagram illustrating a sixth preferred embodiment of a method for making a female member of a hook-and-loop fastener according to this invention;

FIG. 9 is a schematic perspective diagram illustrating a seventh preferred embodiment of a method for making a female member of a hook-and-loop fastener according to this invention;

FIG. 10 is a schematic perspective diagram illustrating an eighth preferred embodiment of a method for making a female member of a hook-and-loop fastener according to this invention; and

FIG. 11 is a schematic perspective diagram illustrating a ninth preferred embodiment of a method for making a female member of a hook-and-loop fastener according to this invention.

### DETAILED DESCRIPTION OF THE PREFERRED EMBODIMENTS

Before the present invention is described in greater detail with reference to the preferred embodiments, it should be noted that like elements are denoted by the same reference numbers in the following description.

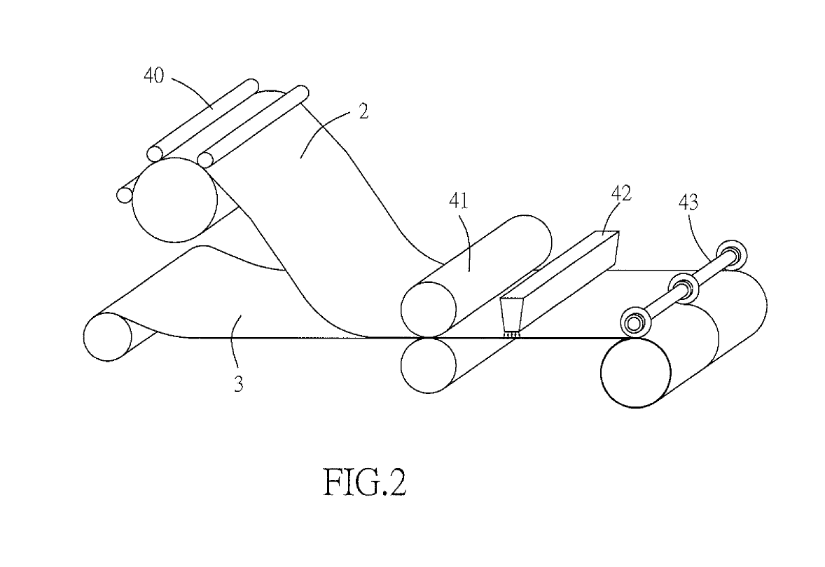

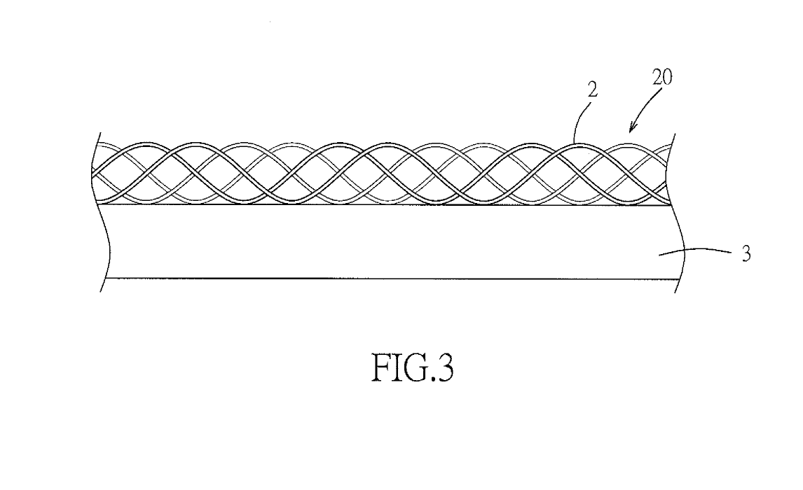

Referring to FIGS. 2 and 3, a first preferred embodiment of a method for making a female member of a hook-and-loop fastener according to this invention includes the steps of:
(a) bonding together a base layer 3 and a surface layer 2, that is formed from a fiber material and that is superimposed on the base layer 3, by applying heat to the surface layer 2 so that fibers of the surface layer 2 are curled; and
(b) immediately after step (a), subjecting the surface layer 2 to a rapid cooling treatment so as to set the curled fibers of the surface layer 2.

In this embodiment, step (a) is conducted by passing the base layer 3 and the surface layer 2 through a hot-pressing roll device 41, and heat-laminating the base layer 3 to the surface layer 2.

In this embodiment, step (b) is conducted by blowing cooling air toward the surface layer 2.

In this embodiment, the base layer 3 and the surface layer 2 are made from different fibrous materials. Preferably, the surface layer 2 is made of an unbound complex fiber web, such as PE/PP or PE/PET, and has a fiber fineness ranging from 1.5 deniers to 6 deniers and a fiber length ranging from 25 mm to 64 mm. Preferably, the base layer 3 is made of a material selected from the group consisting of a complex spunbond nonwoven, a complex staple nonwoven, a paper-fiber-containing nonwoven, and a plastic film. When the base layer 3 is made of a complex spunbond nonwoven, the preferred fiber fineness thereof ranges from 1.5 deniers to 3 deniers.

Specifically, in this embodiment, the surface layer 2 is conveyed by a carding device 40 and is superimposed on the base layer 3. Thereafter, the surface layer 2 and the base layer 3 are thermally pressed to bond together by heat-laminating using the hot-pressing roll device 41. The hot-pressing roll device 41 has particular patterns on surfaces thereof. The fibers of the surface layer 2 are thermally curled by heating with pressing, and the surface layer 2 is then subjected to the rapid cooling treatment by passing through a cooling air device 42 which blows cooling air at a work temperature ranging from 0° C. to 30° C. toward the surface layer 2, so as to rapidly set the curled fibers of the surface layer 2 to keep them in bulk state. The female member 20 of the hook-and-loop fastener is thus formed. A cutting device 43 is provided to split the female member 20 of the hook-and-loop fastener into strips, which are subsequently collected in rolls. In this embodiment, the female member 20 of the hook-and-loop fastener is split into two strips, but the invention should not be restricted thereto. The spacing distance between cutting blades of the cutting device 43 can be adjusted depending on actual requirements. Since the technology regarding the hot-pressing roll device 41 and the cutting device 43 are well known in the art, they will not be further described herein for the sake of brevity.

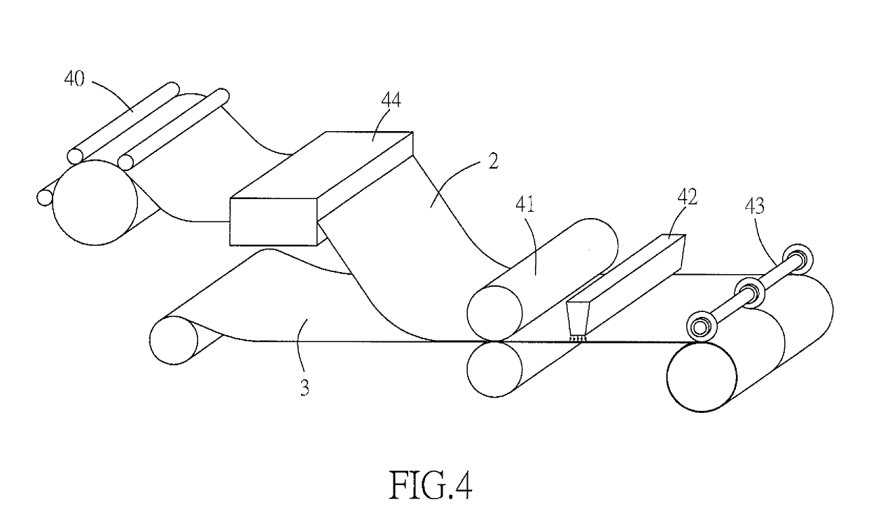

Referring to FIG. 4, a second preferred embodiment of a method for making a female member of a hook-and-loop fastener according to the present invention is substantially similar to the first preferred embodiment, except that, after the surface layer 2 is conveyed using the carding device 40, the surface layer 2 is subjected to a heating treatment by passing through a hot air device 44 which blows hot air toward the surface layer 2 so that the unbound complex fiber web is formed into an air-through nonwoven. The surface layer 2 in a form of the air-through nonwoven then bonds to the base layer 3 by passing them through the hot-pressing roll device 41.

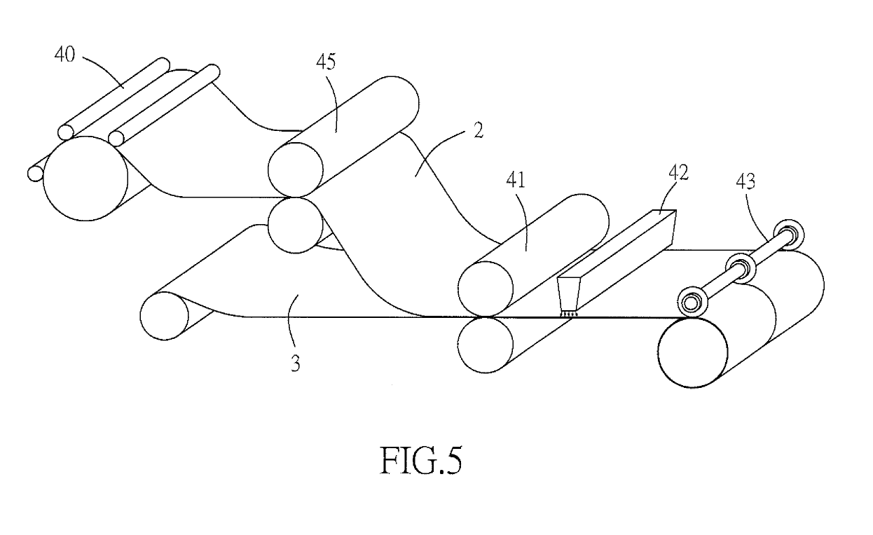

Referring to FIG. 5, a third preferred embodiment of a method for making a female member of a hook-and-loop fastener according to the present invention is substantially similar to the first preferred embodiment, except that, after the surface layer 2 is conveyed using the carding device 40, a hot-pressing feed roll device 45 is provided to conduct the heating treatment, in which the unbound complex fiber web passes through the hot-pressing feed roll device 45 to form into a thermal bonding nonwoven. The surface layer 2 in a form of the thermal bonding nonwoven then bonds to the base layer 3 by passing them through the hot-pressing roll device 41.

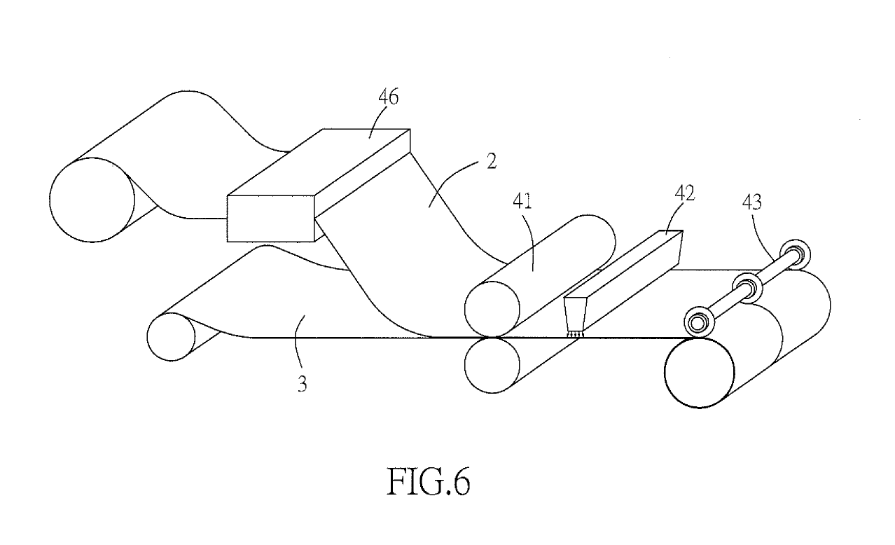

Referring to FIG. 6, a fourth preferred embodiment of a method for making a female member of a hook-and-loop fastener according to the present invention is substantially similar to the first preferred embodiment, except that, in this embodiment, the surface layer 2 is made of a material selected from the group consisting of an air-through nonwoven, a thermal bonding nonwoven, a spunlaced nonwoven, and a jacquard spunlaced nonwoven. The surface layer 2 is heated directly using a heating device 46, so that the fibers of the surface layer 2 are further thermally curled. The surface layer 2 treated using the heating device 46 then bonds to the base layer 3 by passing them through the hot-pressing roll device 41. The heating device 46 may be a heater or a far-infrared machine.

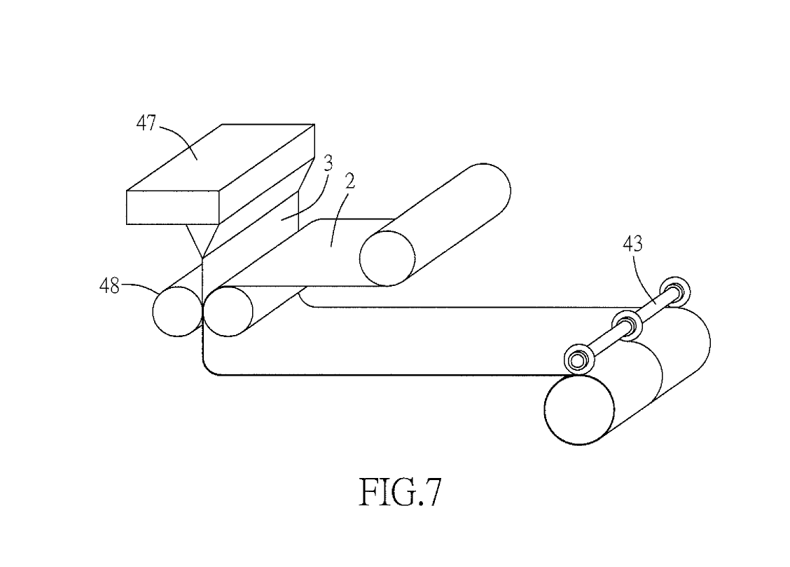

Referring to FIG. 7, a fifth preferred embodiment of a method for making a female member of a hook-and-loop fastener according to the present invention is illustrated. In this embodiment, the surface layer 2 is made of a material selected from the group consisting of an air-through nonwoven, a thermal bonding nonwoven, a spunlaced nonwoven, and a jacquard spunlaced nonwoven. The base layer 3 is made of a plastic film. A laminating machine 47 is used to form the base layer 3 in a form of a plastic film, which is laminated with the surface layer 2 to form a laminate. The laminate is then subjected to the rapid cooling treatment by passing through a cooling roll device 48. The temperature of the rapid cooling treatment ranges from 0° C. to 15° C. The curled fibers of the surface layer 2 could be rapidly cooled and set so as to keep the curled fibers of the surface layer 2 in bulk state. The female member 20 of the hook-and-loop fastener (as shown in FIG. 3) is thus formed. Finally, like the first preferred embodiment, the female member 20 of the hook-and-loop fastener is split into strips and collected in rolls.

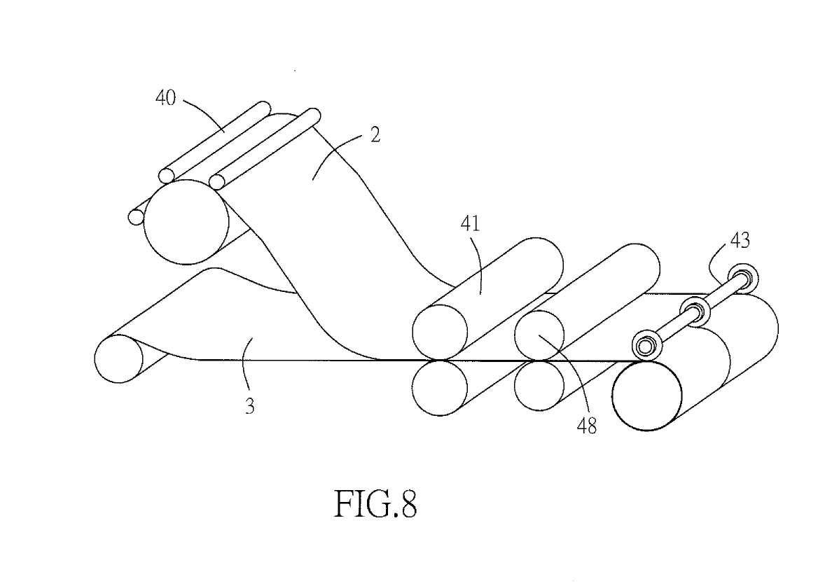

Referring to FIG. 8, a sixth preferred embodiment of a method for making a female member of a hook-and-loop fastener according to the present invention is substantially similar to the first preferred embodiment, except that, in this embodiment, the cooling roll device 48 is used to replace the cooling air device 42 for the rapid cooling treatment.

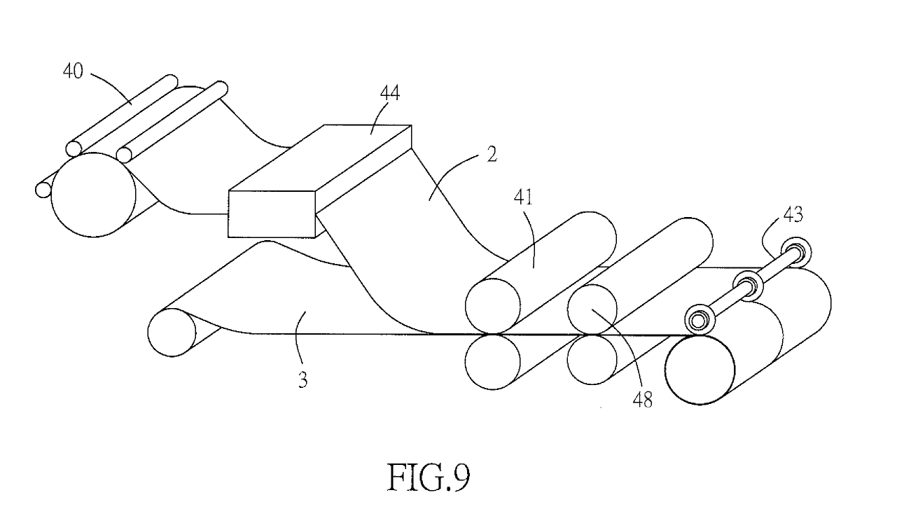

Referring to FIG. 9, a seventh preferred embodiment of a method for making a female member of a hook-and-loop fastener according to the present invention is substantially similar to the second preferred embodiment, except that, in this embodiment, the cooling roll device 48 is used to replace the cooling air device 42 for the rapid cooling treatment.

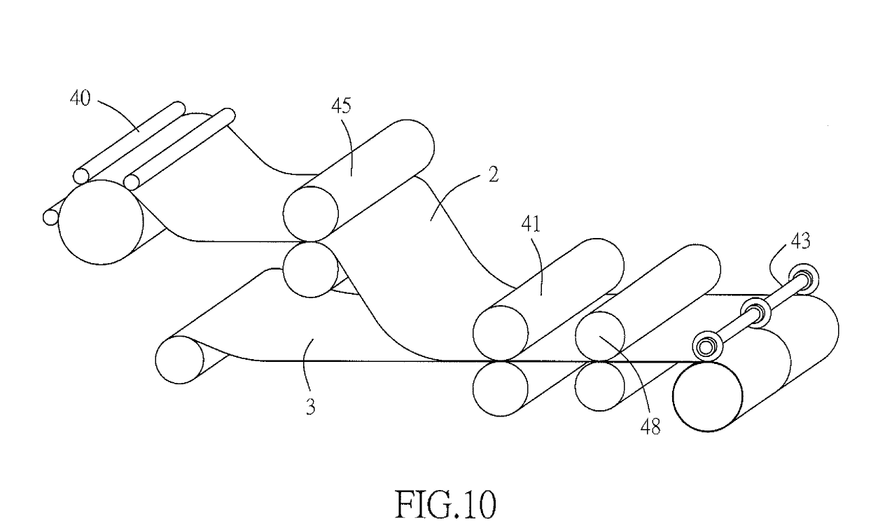

Referring to FIG. 10, an eighth preferred embodiment of a method for making a female member of a hook-and-loop fastener according to the present invention is substantially similar to the third preferred embodiment, except that, in this embodiment, the cooling roll device 48 is used to replace the cooling air device 42 for the rapid cooling treatment.

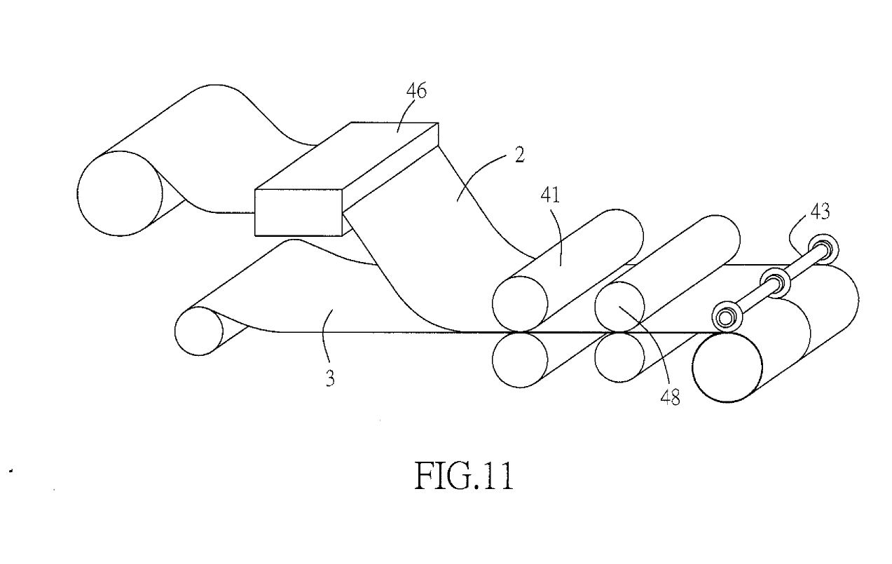

Referring to FIG. 11, a ninth preferred embodiment of a method for making a female member of a hook-and-loop fastener according to the present invention is substantially similar to the fourth preferred embodiment, except that, in this embodiment, the cooling roll device 48 is used to replace the cooling air device 42 for the rapid cooling treatment.

Referring to FIG. 3, the female member 20 of the hook-and-loop fastener made from the foregoing preferred embodiments could keep the fibers of the surface layer 2 in bulk state by the rapid cooling treatment. When a male member (not shown) and the female member 20 are brought face-to-face and are pressed toward each other, hooks of the male member (not shown) would easily tangle with the loops on the fibers of the surface layer 2 in the female member 20, thereby creating a plurality of mechanical connections, so that the male member and the female member 20 have superior binding force.

### [Evaluation]

The female members 20 made from the foregoing first to fifth preferred embodiments served as examples as shown in Table 1 and were evaluated according to a peel strength test and a shear strength test between the hooks of male members and the loops of female members. The female members made without the rapid cooling treatment served as comparative examples as shown in Table 1 and were evaluated according to the same peel strength test and the same shear strength test. The female members of the comparative examples were made using a material and a manufacturing process identical to the material and the manufacturing process for the examples except that the rapid cooling treatment was not used. The evaluation methods will be described below.

### 90° Peel Strength Test

The method for 90° peel strength test between the hooks of male members and the loops of female members was conducted in accordance with JTM-1221-C. Each of the examples and comparative examples was prepared as follows:

1. A female member of the hook-and-loop fastener was cut into a test piece of 25 mm×20 mm (MD×CD, MD: Machine Direction, CD: Cross Direction). The test piece was bonded to a standard adhesive tape which had an exposed area, and a paper (one inch width) was used to cover the exposed area.

2. A male member of 50 mm×100 mm (MD×CD) was bonded to a stainless steel plate.

The test will be described below:
a. CD was the peel test direction;
b. A 90° peel tester was set at a lower clamp head on a clamp of a tension machine.
c. A test speed of the tension machine was set at 300 mm/min and a diagram speed was set at 300 mm/min.
d. The female member was lightly put on the male member. A handheld roller or an electromotive roller was used to roll and press them together to and fro once in the CD direction with 2 kg load at 300 mm/min.
e. After step (d), the bonded female and male members were disposed on a 90° shear Jig. A balance weight of 1 kg was hung to a hanger of the 90° shear Jig for 2 seconds. A stapler or a binder clip was used as the hanger that was disposed at an extending direction of the paper.
f. The balance weight and the hanger were removed and the bonded female and male members were disposed at the 90° peel tester. An end of the extended paper was disposed at an upper clamp head of the tension machine.
g. Average values of the peel strength were obtained from the peel strength diagram. The average values were calculated by calculating an average peeling area from the peel strength diagram. The average peeling area was a peeling distance of 20 mm from the start of peeling.

### Shear Strength Test

The method for shear strength test between the hooks of male members and the loops of female members was conducted in accordance with JTM-1235-A. Each of the examples and comparative examples was prepared as follows:

1. A female member of the hook-and-loop fastener was cut into a test piece of 25 mm×20 mm (MD×CD). This test piece was bonded to a standard adhesive tape which had an exposed area. A PET film was used to cover the exposed area.

2. A male member of 50 mm×100 mm (MD×CD) was bonded to a stainless steel plate.

The test will be described below:
a. The CD of the male member and the CD of the female member were respectively the testing directions.
b. The female member was lightly put on the male member. A handheld roller or an electromotive roller was used to roll and press them together to and fro once in the CD direction with 2 kg load at 300 mm/min.
c. After step (b), the bonded female and male members were disposed at the upper and lower clamp heads of the tension machine to be tested with a testing speed of 30 mm/min.
d. The shear strength values were recorded.

### [Experimental Results]

In the first to fifth preferred embodiments, the examples 1, 2, 3, 4, and 5 were denoted. Accordingly, the comparative examples 1, 2, 3, 4, and 5 were denoted. The experimental results are shown in Table 1.

TABLE 1

| | Peel Strength Averages (N) | | Shear Strength (N) | |
|---|---|---|---|---|
| | | Comparative | | Comparative |
| sample numbers | Examples | Examples | Examples | Examples |
| 1 | 2.8 | 2.1 | 55.0 | 41.0 |
| 2 | 2.1 | 1.5 | 42.0 | 31.5 |
| 3 | 1.5 | 1.1 | 35.0 | 26.0 |
| 4 | 2.5 | 1.9 | 48.0 | 36.0 |
| 5 | 2.0 | 1.5 | 40.0 | 30.0 |

Referring to Table 1, the strength of peel test and shear test in examples 1 to 5 are 25% greater than those in comparative examples 1 to 5. It can be seen that the female member subjected to the rapid cooling treatment could enhance an interlocking strength between the female member and the male member.

To sum up, in the method for making the female member of the hook-and-loop fastener according to this invention, after bonding the surface layer 2 and the base layer 3 together, the surface layer 2 was treated with the rapid cooling treatment immediately so as to set the curled fibers of the surface layer 2. Therefore, when the female member 20 and male member of the hook-and-loop fasteners are pressed together, the hooks of the male member easily clasp the loops on the surface layer 2 of the female member 20 so as to generate a superior binding force.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A method for making a female member of a hook-and-loop fastener, comprising the steps of:
(a) bonding together a base layer and a surface layer, that is formed from a fiber material and that is superimposed on the base layer, by applying heat to the surface layer so that fibers of the surface layer are curled; and
(b) immediately after step (a), subjecting the surface layer to a rapid cooling treatment so as to set the curled fibers of the surface layer.

2. The method according to claim 1, wherein the base layer is made of a material selected from the group consisting of a complex spunbond nonwoven, a complex staple nonwoven, a paper-fiber-containing nonwoven, and a plastic film.

3. The method according to claim 2, wherein the surface layer is made of a material selected from the group consisting of an unbound complex fiber web, an air-through nonwoven, a thermal bonding nonwoven, a spunlaced nonwoven, and a jacquard spunlaced nonwoven.

4. The method according to claim 1, wherein the surface layer is made of a material selected from the group consisting of an unbound complex fiber web, an air-through nonwoven, a thermal bonding nonwoven, a spunlaced nonwoven, and a jacquard spunlaced nonwoven.

5. The method according to claim 1, wherein step (a) is conducted by passing the base layer and the surface layer through a hot-pressing roll device.

6. The method according to claim 1, wherein step (b) is conducted by blowing cooling air toward the surface layer.

7. The method according to claim 1, wherein step (b) is conducted by passing the surface layer through a cooling roll device.

8. The method according to claim 1, wherein step (b) is conducted at a work temperature ranging from 0° C. to 30° C.

9. The method according to claim 1, wherein step (a) is conducted by heat-laminating the base layer to the surface layer.

10. The method according to claim 9, wherein the surface layer is made of a material selected from the group consisting of an unbound complex fiber web, an air-through nonwoven, a thermal bonding nonwoven, a spunlaced nonwoven, and a jacquard spunlaced nonwoven.

11. The method according to claim 10, wherein the base layer is made of a plastic film.
